(19) United States
(12) Patent Application Publication
(10) Pub. No.: US 2024/0119251 A1
(43) Pub. Date: Apr. 11, 2024

(54) FAST GRAPH MODEL SELECTION VIA META-LEARNING

(71) Applicant: Adobe Inc., San Jose, CA (US)

(72) Inventor: Ryan Rossi, Santa Clara, CA (US)

(21) Appl. No.: 17/936,099

(22) Filed: Sep. 28, 2022

(51) Int. Cl. G06N 3/04; G06N 3/08

(52) U.S. Cl. CPC G06N 3/04; G06N 3/08

(57) ABSTRACT

Methods, systems, and non-transitory computer readable storage media are disclosed for utilizing machine-learning to automatically select a machine-learning model for graph learning tasks. The disclosed system extracts, utilizing a graph feature machine-learning model, meta-graph features representing structural characteristics of a graph representation comprising a plurality of nodes and a plurality of edges indicating relationships between the plurality of nodes. The disclosed system also generates, utilizing the graph feature machine-learning model, a plurality of estimated graph learning performance metrics for a plurality of machine-learning models according to the meta-graph features. The disclosed system selects a machine-learning model to process data associated with the graph representation according to the plurality of estimated graph learning performance metrics.

### BACKGROUND

Recent years have seen significant advancements in the fields of digital data analysis and machine-learning. Many industries utilize machine-learning techniques to determine relationships between data points and perform tasks (e.g., making inferences from data) based on those relationships. For example, many entities have large amounts of data in datasets related to different domains, such as biological information, technological information, social networking information, financial transaction information, personal information, and others. Typically, each domain has different types of data and different relationships between data points in the datasets, resulting in graphs representing the data points and their corresponding relationships having different structural properties. Accordingly, selecting an appropriate machine-learning model to accurately capture and interpret relationships between data points is an important and often difficult aspect of processing the data.

### SUMMARY

This disclosure describes one or more embodiments of methods, non-transitory computer readable media, and systems that solve the foregoing problems (in addition to providing other benefits) by utilizing machine-learning to automatically select a machine-learning model for graph learning tasks. The disclosed systems utilize a graph feature machine-learning model to extract meta-graph features representing structural characteristics of nodes and edges in a graph representation. The disclosed systems also utilize the graph feature machine-learning model to generate estimated performances of a plurality of machine-learning models according to the meta-graph features and learned mappings between meta-graph features and model performance. The disclosed systems select a machine-learning model from the plurality of machine-learning models for processing data associated with the graph representation according to the estimated performances. The disclosed systems thus provide efficient and accurate machine-learning model selection for various graph learning tasks.

### BRIEF DESCRIPTION OF THE DRAWINGS

Various embodiments will be described and explained with additional specificity and detail through the use of the accompanying drawings in which:

FIG. 1 illustrates an example system environment in which a model selection system can operate in accordance with one or more implementations.

FIG. 2 illustrates a diagram of the model selection system utilizing a graph feature machine-learning model selecting a machine-learning model for a graph representation in accordance with one or more implementations.

FIG. 3 illustrates a diagram of the model selection system extracting meta-graph features and generating estimated graph learning performance metrics for a graph representation in accordance with one or more implementations.

FIG. 4 illustrates a diagram of the model selection system generating a feature vector based on local and global features of a graph representation in accordance with one or more implementations.

FIG. 5 illustrates a diagram of the model selection system determining mappings between meta-graph features and graph learning performance metrics for a graph feature machine-learning model in accordance with one or more implementations.

FIG. 6 illustrates a diagram of the model selection system of FIG. 1 in accordance with one or more implementations.

FIG. 7 illustrates a flowchart of a series of acts for selecting a machine-learning model for a graph learning task based on meta-graph features of a graph representation in accordance with one or more implementations.

FIG. 8 illustrates a block diagram of an exemplary computing device in accordance with one or more embodiments.

### DETAILED DESCRIPTION

This disclosure describes one or more embodiments of a model selection system that maps structural features of graph representations of datasets for selecting machine-learning models to use in connection with datasets. Conventional image generation systems have a number of shortcomings in relation to efficiency and accuracy of operation. For example, some conventional data processing systems select models for use in processing a particular dataset using ad hoc approaches. In particular, such conventional systems select each machine-learning model at the time of processing from a subset of popular (e.g., frequently used) machine-learning models. While popular machine-learning models are often used due to their flexibility and/or ease-of-use, merely selecting an often used model due to its popularity can result in poor accuracy with a given dataset. Indeed, graph representations in different data domains tend to have different structural properties or other characteristics for which some models perform better than others. Thus, the conventional systems fail to account for these different aspects of processed data during model selection, resulting in worse model performance.

To overcome the inaccuracies of conventional systems that merely select from a subset of popular machine-learning models, other conventional systems compare model performances of a plurality of machine-learning models prior to selecting a model for a particular dataset. Specifically, these conventional systems train each machine-learning model on the dataset and then compare the performance of the trained models to determine a model that performs best. Although such conventional systems can sometimes provide accurate selection of a best machine-learning model (e.g., the best performing model) for a given dataset, training a plurality of machine-learning models for each separate dataset is a time-consuming and resource-intensive task, especially in scenarios involving a large number of models and/or large/varied datasets. Additionally, these conventional systems are impractical and unusable in many circumstances in which time or resources are limited.

As mentioned, the model selection system uses structural features of graph representations of datasets to select machine-learning models for graph learning tasks on the datasets. In one or more embodiments, the model selection system utilizes a graph feature machine-learning model to extract meta-graph features representing local and global structural characteristics of a graph representation. The model selection system also utilizes the graph feature machine-learning model to infer model performance for each of a plurality of machine-learning models according to the extracted meta-graph features based on learned mappings. Additionally, the model selection system uses the inferred model performances to select a machine-learning model appropriate for processing data associated with the graph representation.

In one or more embodiments, the model selection system extracts meta-graph features from a graph representation. Specifically, the model selection system utilizes a graph feature machine-learning model to extract local structural characteristics for nodes and edges in the graph representation. Additionally, the model selection system utilizes the graph feature machine-learning model to extract global structural characteristics associated with the graph representation. The model selection system further utilizes the local structural characteristics and the global structural characteristics to generate a meta-graph feature comprising a feature vector representing the structural characteristics of the graph representation.

In one or more additional embodiments, the model selection system estimates graph learning performance metrics of a plurality of machine-learning models for a graph representation. In particular, the model selection system generates estimated model performances of the plurality of machine-learning models in connection with the graph representation via the meta-graph features. For example, the model selection system determines an estimated model performance for a particular machine-learning model according to the meta-graph features of the graph representation based on learned mappings.

In some embodiments, the model selection system trains the graph feature machine-learning model to learn mappings of model performances and meta-graph features. For instance, the model selection system determines a dataset of training graph representations including a variety of different structural characteristics. The model selection system also determines model performances for the plurality of machine-learning models according to the different structural characteristics of the training graph representations. The model selection system thus learns mappings of model performances of the machine-learning models and meta-graph features according to the dataset of training graph representations. To illustrate, the model selection system learns the mappings via a meta-graph including nodes representing the machine-learning models and the graph representations with edges indicating relationships between the machine-learning models and graph representations.

In one or more embodiments, the model selection system selects a machine-learning model for a graph representation. In particular, the model selection system utilizes estimated graph learning performance metrics to determine a particular machine-learning model to use with the graph representation. For example, the model selection system selects a machine-learning model to process data associated with the graph representation based on the estimated graph learning performance metrics generated for the extracted meta-graph features. Accordingly, the model selection system automatically selects the best machine-learning model for the graph representation based on the structural characteristics of the graph representation.

The disclosed model selection system provides a number of advantages over conventional systems. For example, the model selection system improves the accuracy of computing devices that implement data processing operations. In contrast to conventional systems that merely select from a subset of popular machine-learning models to process new datasets, the model selection system provides accurate selection of machine-learning models for processing data based on meta-graph features of graph representations of the data. In particular, by learning relationships between meta-graph features of graph representations and model performances of various machine-learning models, the model selection system can accurately estimate model performances for any given dataset based on the structural properties of a graph representation of the dataset. For example, the model selection system selects the most appropriate machine-learning model for processing data associated with a given graph representation via learned mappings of meta-graph features representing graph representations to model performances of a plurality of machine-learning models.

Additionally, the model selection system improves the efficiency of computing devices that implement data processing operations. In contrast to conventional systems that train and analyze each machine-learning model individually to select a model for a given dataset, the model selection system automatically infers an appropriate model for a given dataset without any model training or testing at the time of inference. Specifically, by pre-training a graph feature machine-learning model to learn relationships between meta-graph features of graph representations and model performances of machine-learning models, the model selection system provides fast and accurate selection of a machine-learning model for a given dataset. More specifically, the model selection system utilizes the learned mappings to efficiently estimate model performance based on extracted meta-graph features of a graph representation of a new dataset without training or testing the model in connection with the new dataset Eliminating the need to train and test models for each new dataset saves a significant amount of time over conventional systems, especially when dealing with hundreds of different models using various different methods and parameter configurations.

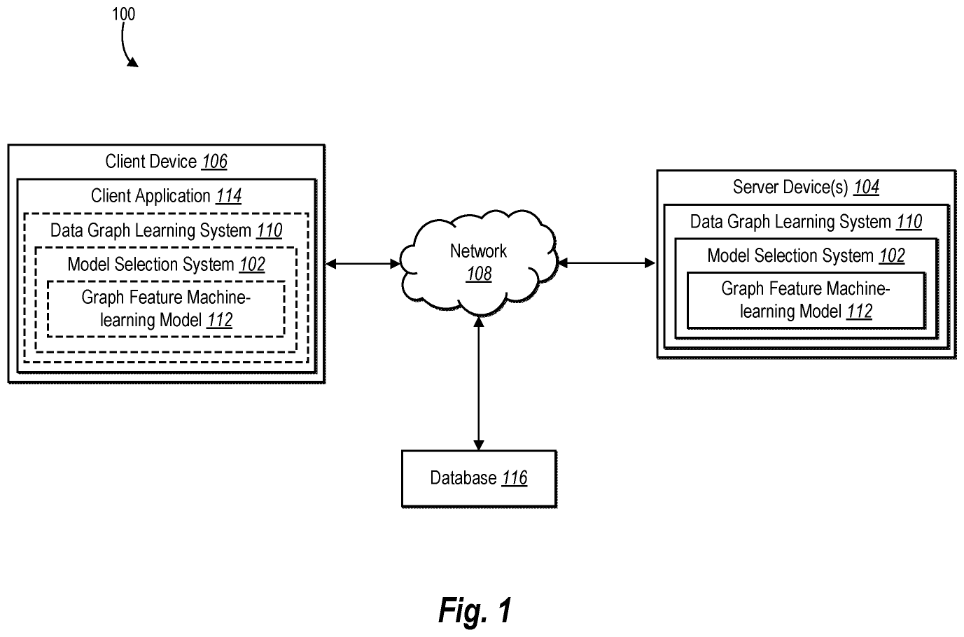

Turning now to the figures, FIG. 1 includes an embodiment of a system environment 100 in which an model selection system 102 is implemented. In particular, the system environment 100 includes server device(s) 104 and a client device 106 in communication via a network 108. Moreover, as shown, the server device(s) 104 include a data graph learning system 110, which includes the model selection system 102. FIG. 1 illustrates that the model selection system 102 also includes a graph feature machine-learning model 112. Additionally, the client device 106 includes a client application 114, which optionally includes the data graph learning system 110 and the model selection system 102, which further includes the graph feature machine-learning model 112. In one or more embodiments, as illustrated in FIG. 1, the system environment 100 also includes a database 116 in communication with the server device(s) 104 and/or the client device 106.

As shown in FIG. 1, the server device(s) 104 includes or hosts the data graph learning system 110. The data graph learning system 110 include, or be part of, one or more systems that implement data processing via graph representations. For example, the data graph learning system 110 provides tools for performing various operations on data (e.g., in the database 116). To illustrate, the data graph learning system 110 provides tools to utilize one or more machine-learning models to perform data processing operations, including, but not limited to, link prediction, node classification, graph classification, node clustering, or graph modification. More specifically, the data graph learning system 110 provides tools for determining and/or using information associated with data points and relationships between data points to make inferences about the data points and/or to make predictions based on the data points. In some embodiments, the data graph learning system 110 communicates with the client device 106 and/or the database 116 to obtain a dataset and/or to perform graph learning tasks associated with the dataset.

According to one or more embodiments, the data graph learning system 110 utilizes the model selection system 102 to select a machine-learning model for a graph learning task on a dataset. In particular, the model selection system 102 automatically selects a machine-learning model from a plurality of machine-learning models to use in processing data associated with a graph representation of the dataset. For example, the model selection system 102 utilizes the graph feature machine-learning model 112 to extract features from the graph representation. The model selection system 102 also utilizes the graph feature machine-learning model 112 to generate predicted model performances for the plurality of machine-learning models (e.g., for a graph learning task on the graph representation) based on the extracted features. Additionally, the model selection system 102 selects a machine-learning model for graph learning tasks in connection with the graph representation based on the predicted model performances. In additional embodiments, the data graph learning system 110 communicates with the database 116 or one or more other systems to obtain machine-learning models for training the graph feature machine-learning model 112 and/or for generating estimated model performances of the machine-learning models for a given dataset.

In one or more embodiments, the data graph learning system 110 (or another system) uses processed data in a variety of applications. For example, the data graph learning system 110 (e.g., via the model selection system 102) provides recommendations and/or access to one machine-learning models for performing graph learning tasks on a dataset. Additionally, the data graph learning system 110 uses information associated with the graph learning tasks to generate analyzed data to provide to a third-party system or another device (e.g., for display at the client application 114 of the client device 106) via the network 108. To illustrate, the data graph learning system 110 communicates with the client device 106 to provide the results of the graph learning tasks for use in operations such as modifying one or more computing applications (e.g., an application that generates or collects data in the database 116), generating content in connection with providing a service (e.g., modifying a social networking platform), etc.

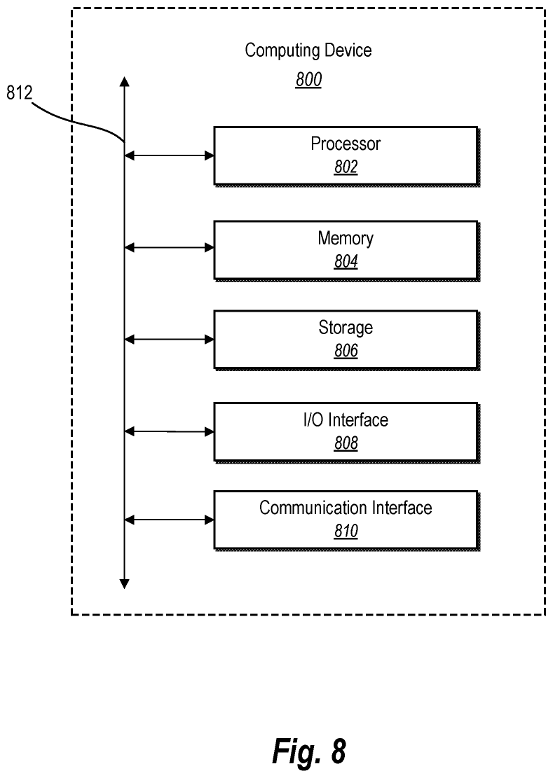

In one or more embodiments, the server device(s) 104 include a variety of computing devices, including those described below with reference to FIG. 8. For example, the server device(s) 104 includes one or more servers for storing and processing data associated with selecting and/or using machine-learning models in graph learning tasks. In some embodiments, the server device(s) 104 also include a plurality of computing devices in communication with each other, such as in a distributed storage environment. In some embodiments, the server device(s) 104 include a content server. The server device(s) 104 also optionally includes an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 8. Furthermore, although not shown in FIG. 1, the client device 106 can be operated by a user (e.g., a user included in, or associated with, the system environment 100) to perform a variety of functions. In particular, the client device 106 performs functions such as, but not limited to, accessing, viewing, and interacting with a variety of digital content (e.g., datasets associated with a particular domain). In some embodiments, the client device 106 also performs functions for generating, capturing, or accessing data to provide to the data graph learning system 110 and the model selection system 102 in connection with performing graph learning tasks on datasets. For example, the client device 106 communicates with the server device(s) 104 via the network 108 to provide information (e.g., user interactions) associated with datasets (e.g., stored at the database 116). Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 8.

Although FIG. 1 illustrates the server device(s) 104 and the client device 106 communicating via the network 108, in alternative embodiments, the various components of the system environment 100 communicate and/or interact via other methods (e.g., the server device(s) 104 and the client device 106 can communicate directly). Furthermore, although FIG. 1 illustrates the model selection system 102 being implemented by a particular component and/or device within the system environment 100, the model selection system 102 can be implemented, in whole or in part, by other computing devices and/or components in the system environment 100 (e.g., the client device 106).

In particular, in some implementations, the model selection system 102 on the server device(s) 104 supports the model selection system 102 on the client device 106. For instance, the server device(s) 104 generates or obtains the model selection system 102 (including the graph feature machine-learning model 112) for the client device 106. The server device(s) 104 trains and provides the model selection system 102 and the graph feature machine-learning model 112 to the client device 106 for performing a model selection process at the client device 106. In other words, the client device 106 obtains (e.g., downloads) the model selection system 102 and the graph feature machine-learning model 112 from the server device(s) 104. At this point, the client device 106 is able to utilize the model selection system 102 (with the graph feature machine-learning model 112) to select machine-learning models for graph learning tasks independently from the server device(s) 104.

In alternative embodiments, the model selection system 102 includes a web hosting application that allows the client device 106 to interact with content and services hosted on the server device(s) 104. To illustrate, in one or more implementations, the client device 106 accesses a web page supported by the server device(s) 104. The client device 106 provides input to the server device(s) 104 to perform model selection and/or graph learning operations, and, in response, the model selection system 102 or the data graph learning system 110 on the server device(s) 104 performs operations to select a model and/or execute a graph learning task. The server device(s) 104 provide the output or results of the operations to the client device 106.

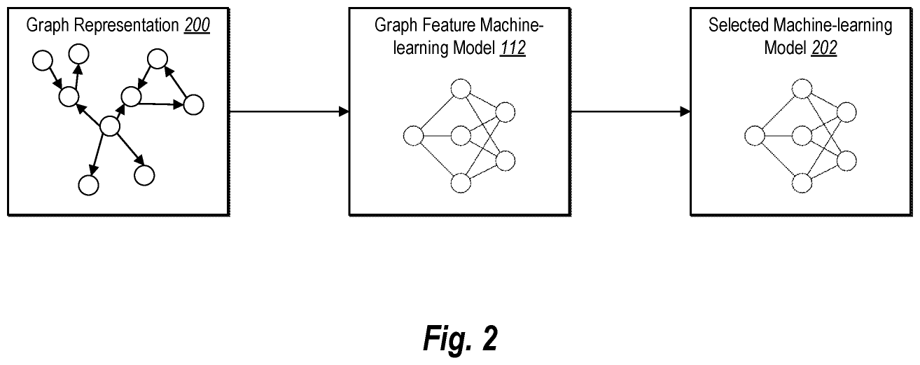

As mentioned, the model selection system 102 selects machine-learning models for graph learning tasks on a graph representation of a dataset. FIG. 2 illustrates an overview of the model selection system 102 analyzing a dataset to select a machine-learning model for processing data in the dataset. Specifically, FIG. 2 illustrates that the model selection system 102 utilizes a graph feature machine-learning model 112 to select a best performing model of a plurality of machine-learning models for processing data in a given dataset.

As illustrated in FIG. 2, the model selection system 102 determines a graph representation 200 of a dataset. According to one or more embodiments, the graph representation 200 includes a representation of data including a plurality of nodes and edges. Specifically, the graph representation 200 includes a plurality of nodes corresponding to data points, topics, or concepts in a dataset and a plurality of edges indicating relationships between the data points, topics, or concepts in the dataset. A dataset can include any type and/or amount of data, such that the graph representation 200 of the dataset includes any number of nodes linked according to the type of information in the dataset.

Additionally, in one or more embodiments, the graph representation 200 indicates relationship strengths between data points or concepts based on edges and corresponding nodes connected by the edges. Accordingly, an edge between a given pair of nodes can indicate a strength and/or a directionality of a relationship between two data points or concepts. To illustrate, the graph representation 200 represents a dataset in a social networking domain and includes nodes corresponding to user profiles and edges indicating a strength and/or a directionality of a relationship between each pair of user profiles if any such relationship exists.

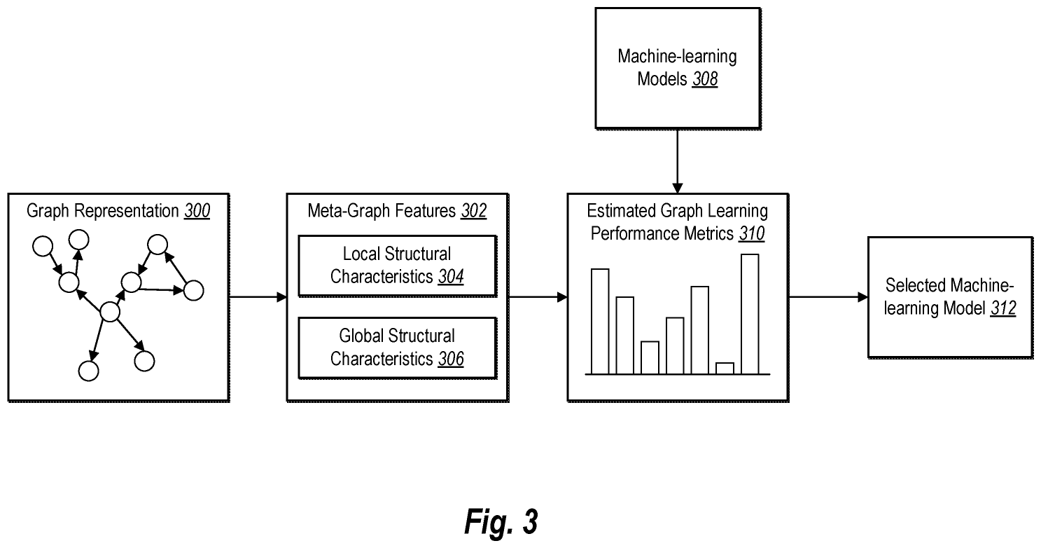

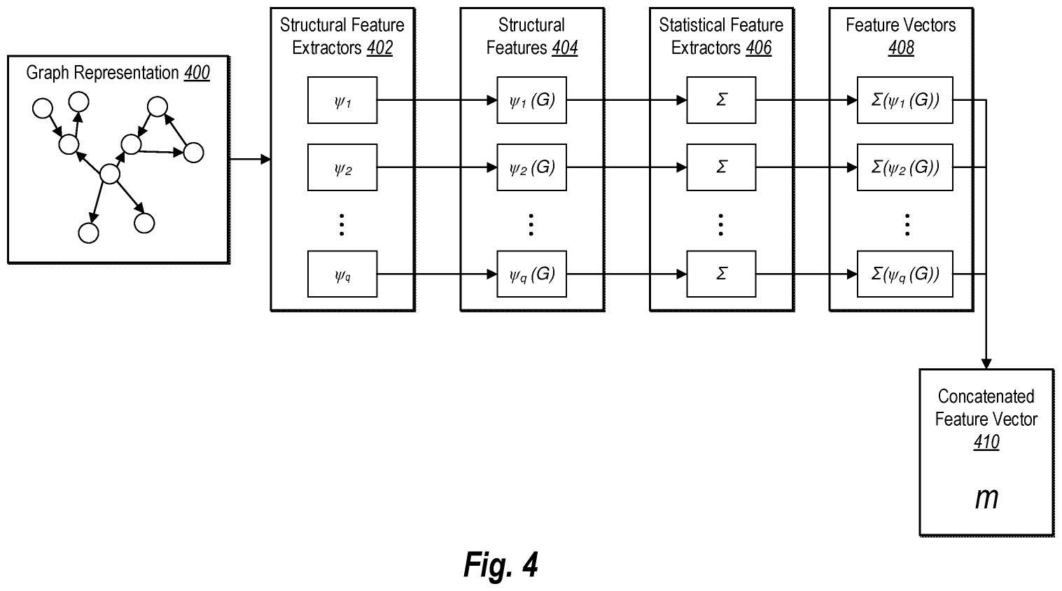

In one or more embodiments, the model selection system 102 utilizes the graph feature machine-learning model 112 to determine a selected machine-learning model 202 for use in processing data associated with the graph representation 200. In particular, the model selection system 102 extracts meta-graph features representing structural characteristics of the graph representation 200. For example, the model selection system 102 determines local and global structural characteristics of the graph representation 200 based on nodes and edges in the graph representation 200. FIGS. 3-4 and the corresponding description provide additional detail with respect to extracting meta-graph features from a graph representation.

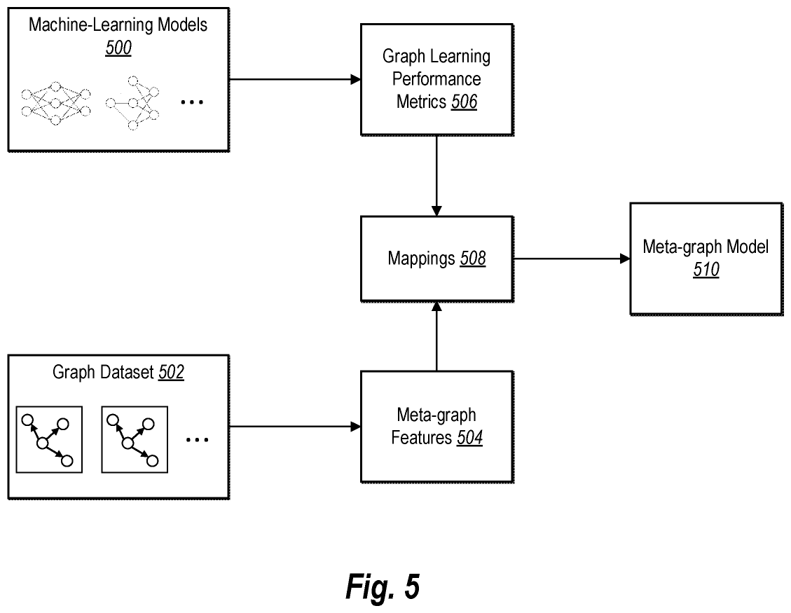

Furthermore, in connection with extracting the meta-graph features from the graph representation 200, the model selection system 102 utilizes the graph feature machine-learning model 112 to predict model performance of a plurality of machine-learning models. Specifically, the model selection system 102 utilizes the meta-graph features of the graph representation 200 to estimate graph learning performance metrics of machine-learning models in graph learning tasks based on learned mappings. FIG. 3 and the corresponding description provide additional detail with respect to estimating graph learning performance metrics for a plurality of machine-learning models. FIG. 5 and the corresponding description provide additional detail with respect to learning mappings of meta-graph features and model performance.

In one or more embodiments, a machine-learning model includes one or more computer algorithms that can be tuned (e.g., trained) based on inputs to approximate unknown functions. In particular, a machine-learning model utilizes algorithms to learn from, and make determinations on, known data by analyzing the known data to learn to generate outputs that reflect patterns and attributes of the known data. For instance, a machine-learning model can include, but is not limited to, one or more neural network layers, such as a multi-layer perceptron, a convolutional neural network, a recurrent neural network, a generative adversarial neural network, a feed forward neural network, or any combination thereof. A machine-learning model can learn high-level abstractions in data to generate data-driven determinations, predictions, or decisions from the known input data. Furthermore, as described herein, in some embodiments, an “image generation neural network”) includes one or more neural network layers for generating one or more synthetic portions of a digital image. In one or more embodiments, the graph feature machine-learning model 112 includes one or more neural network layers to capture structural properties (e.g., in meta-graph features) of the graph representation 200. Furthermore, in one or more embodiments, the graph feature machine-learning model includes one or more neural network layers to learn mappings between meta-graph features of the graph representation 200 and estimated graph learning performance metrics of additional machine-learning models. Additionally, in some embodiments, a machine-learning model (e.g., the selected machine-learning model 202) includes one or more neural network layers to perform one or more graph learning tasks on a graph representation of a dataset.

FIG. 3 illustrates a diagram of the model selection system 102 using meta-graph features extracted from a graph representation to select a machine-learning model. As shown, the model selection system 102 determines a graph representation 300 including a plurality of nodes representing data points, topics, or concepts and a plurality of edges indicating relationships between the nodes. In one or more embodiments, the graph representation 300 includes structural characteristics based on the number of nodes and connections between the nodes according to the data in the corresponding dataset.

According to one or more embodiments, the model selection system 102 extracts meta-graph features 302 representing the structural characteristics of the graph representation 300. As any given graph representation includes a specific structure of nodes and edges, the model selection system 102 utilizes a graph feature machine-learning model to quantify the structural characteristics of the graph representation 300 into a set of features. Specifically, the model selection system 102 utilizes a plurality of feature extractors of the graph feature machine-learning model including to extract local structural characteristics 304 and global structural characteristics 306 from the graph representation 300. More specifically, the model selection system 102 captures a variety of structural properties of the graph representation 300 to leverage broad and detailed information about the data and corresponding relationships of the dataset.

In one or more embodiments, the model selection system 102 extracts the local structural characteristics 304 representing structural properties of individual nodes and/or edges in the graph representation 300. For instance, the model selection system 102 utilizes the graph feature machine-learning model to generate a vector or distribution of values for each node in the graph representation 300, such as, but not limited to, a node degree (or valency) of the node, a number of wedges corresponding to the node, and/or a number of triangles centered at the node. Additionally, the model selection system 102 determines one or more local structural characteristics of edges in the graph representation 300 by determining, for example, the frequency of triangles for each edge. In some embodiments, the model selection system 102 encodes the vector or distribution of values associated with the nodes/edges of the graph representation 300 in an encoded feature vector. Alternatively, the model selection system 102 stores the raw values in a vector or matrix.

According to one or more embodiments, the model selection system 102 also extracts the global structural characteristics 306 from the graph representation. In particular, the model selection system 102 utilizes the graph feature machine-learning model to modify the vectors/matrices generated based on the local structural characteristics 304. For example, the model selection system 102 captures properties of nodes in the graph representation 300, including but not limited to, important scores of nodes, eccentricities of nodes, and/or k-core numbers of nodes in the graph representation 300. To illustrate, the model selection system 102 determines global statistical characteristics of the graph representation 300 based on the number and structure of nodes (and node connectivity) in the graph representation 300. More specifically, the model selection system 102 summarizes the vectors/matrices corresponding to the local structural characteristics 304 to a vector.

In response to extracting the meta-graph features 302 from the graph representation 300, the model selection system 102 determines a model performance of a plurality of machine-learning models 310. In one or more embodiments, the machine-learning models 310 include a plurality of different types of models associated with graph learning tasks. In some embodiments, the machine-learning models 310 also include a plurality of different parameter configurations for a given machine-learning model. Accordingly, the model selection system 102 predicts the performance of a plurality of different models with one or more parameter configurations for each model in connection with the graph representation 300.

To illustrate, the model selection system 102 generates estimated graph learning performance metrics 308 that include various numerical evaluations or scores of a particular machine-learning model based on the meta-graph features 302. For instance, the model selection system 102 generates predictions of the accuracy and/or precision of each of the machine-learning models 310. To illustrate, the model selection system 102 generates an estimated graph learning performance metric that combines the accuracy and precision of a machine-learning model into a single score. Alternatively, the model selection system 102 generates separate estimated graph learning performance metrics for the accuracy and precision.

In one or more embodiments, as mentioned, the model selection system 102 generates the estimated graph learning performance metrics 308 without training the machine-learning models 310 on the graph representation 300 and without performing individual evaluations of the machine-learning models 310 on the graph representation 300. In particular, the model selection system 102 utilizes learned mappings between meta-graph features of a training dataset and graph learning performance metrics of the machine-learning models 310 to generate predictions based on the extracted meta-graph features 302 of the graph representation 300. Accordingly, the model selection system 102 generates the estimated graph learning performance metrics 308 by utilizing the learned mappings to determine likely performances of the machine-learning models 310 for the graph representation according to the local and global structural characteristics indicated by the meta-graph features 302.

In one or more embodiments, the model selection system 102 determines a selected machine-learning model 312 to use in connection with the graph representation 300. Specifically, the model selection system 102 selects a machine-learning model from the plurality of machine-learning models 310 most appropriate for the graph representation 300. More specifically, the model selection system 102 selects the machine-learning model with the highest estimated graph learning performance metric(s) generated based on the meta-graph features 302. For example, the model selection system 102 selects the machine-learning model with the highest accuracy and/or precision according to the estimated graph learning performance metrics 308. To illustrate, the model selection system 102 selects the machine-learning model with the highest estimated graph learning performance metric (e.g., in cases in which the estimated graph learning performance metric represents a combination of the accuracy and precision scores) or with a highest average estimated graph learning performance metric (e.g., in cases in which separate graph learning performance metrics represent the accuracy and precision scores).

FIG. 4 illustrates the model selection system 102 extracting meta-graph features indicating structural characteristics of a graph representation 400. Specifically, the model selection system 102 utilizes a graph feature machine-learning model that includes a plurality of layers for extracting local structural characteristics and global structural characteristics from the graph representation 400. More specifically, the graph feature machine-learning model includes a plurality of extractors to extract the local and global structural characteristics.

In one or more embodiments, the model selection system 102 utilizes the graph feature machine-learning model including a plurality of structural feature extractors 402 to extract local structural characteristics. For example, each structural feature extractor includes one or more neural network layers to extract one or more local structural characteristics of the graph representation 400. To illustrate, as previously mentioned, the model selection system 102 utilizes the graph feature machine-learning model to extract local structural characteristics based on the organization of nodes and edges in the graph representation 400, including, but not limited to, node degrees, number of wedges, number of triangles centered at each node, frequency of triangles for each edge, or other network structural attributes. Additionally, the model selection system 102 utilizes the graph feature machine-learning model to extract global structural characteristics based on the organization of nodes and edges in the graph representation 400, such as, but not limited to, an importance score of each node of the plurality of nodes, an eccentricity of each node of the plurality of nodes, or a k-core number of each node of the plurality of nodes. Accordingly, for example, a first structural feature extractor includes one or more neural network layers to extract a node degree of each node, a second structural feature extractor includes one or more neural network layers to extract a number of wedges for each node, a third structural feature extractor includes one or more neural network layers to extract an eccentricity of each node, etc.

FIG. 4 illustrates that the model selection system 102 utilizes the structural feature extractors 402 to determine structural features 404 of the graph representation 400. Specifically, the structural features 404 include vectors or matrices output by the structural feature extractors 402 according to the structure of the graph representation 400. For instance, a structural feature extractor generates a vector representation for a per-node or per-edge structural characteristic according to the specific feature extractor. Thus, each of the structural feature extractors 402 generates a matrix including rows corresponding to the nodes and edges of the graph representation 400.

Additionally, as illustrated in FIG. 4, the model selection system 102 utilizes the graph feature machine-learning model including statistical feature extractors 406 to further modify the structural features 404. In particular, the statistical feature extractors 406 modify the structural features 404 by determining a plurality of global statistical characteristics of the graph representation 400 based on the extracted structural characteristics. In one or more embodiments, the model selection system 102 applies the statistical feature extractors 406 to each of the structural features 404 to summarize each matrix to a vector. For example, the statistical feature extractors 406 generate feature vectors 408 from the structural features 404 by applying a plurality of statistical functions to the matrices including the structural features 404. To illustrate, the statistical functions include functions to determine a mean, kurtosis, deviation, etc., of the distributions indicated in the matrices, thereby generating a vector of values summarizing the feature distributions of the structural characteristics of the graph representation 400.

In one or more embodiments, as illustrated in FIG. 4, the model selection system 102 generates a concatenated feature vector 410 based on the structural characteristics of the graph representation 400. Specifically, the model selection system 102 utilizes the graph feature machine-learning model to concatenate the feature vectors 408 generated by the statistical feature extractors 406 into a single vector. For instance, the model selection system 102 generates the concatenated feature vector 410 to include a vector with a fixed-dimension including a predetermined number of values according to the structural characteristics and the global statistical characteristics. In additional embodiments, the model selection system 102 also determines global graph statistics such as density or degree assortativity coefficients (e.g., a correlation coefficient of degree between pairs of linked nodes) associated with the graph representation 400 and appends the additional values to the concatenated feature vector 410 (e.g., after or before the feature vectors 408).

In one or more embodiments, by generating the concatenated feature vector 410 from the local and global structural characteristics of the graph representation 400, the model selection system 102 can determine a set of values that provide for consistent evaluation of graph representations. In particular, different graph representations include different structures including different numbers of nodes and/or edges and different organizations of the nodes and edges. Accordingly, the extracted matrices of structural features from the graph representation include different numbers of rows according to the specific numbers and configurations of nodes and edges. To illustrate, generating a concatenated feature vector that includes a specific number of values representing global statistical characteristics of specific types of structural characteristics of each graph representation provides a single vector with a predetermined number of values derived directly from the corresponding graph representation. Furthermore, the model selection system 102 can quantify any pair of graphs using a similarity function over the respective concatenated feature vectors.

According to one or more embodiments, the model selection system 102 learns mappings between structural characteristics of graph representations and model performances. Specifically, FIG. 5 illustrates that the model selection system 102 identifies a plurality of machine-learning models 500 for performing graph learning tasks. Additionally, the model selection system 102 also determines a graph dataset 502 including a plurality of graph representations corresponding to a plurality of datasets. For example, as mentioned, the graph representations of the graph dataset 502 include nodes and edges representing data/topics and relationships between the data/topics in the respective datasets. In some instances, the graph dataset 502 includes graph representations corresponding to a plurality of different domains. In alternative instances, the graph dataset 502 includes graph representations corresponding to a single domain.

In one or more embodiments, as illustrated in FIG. 5, the model selection system 102 determines meta-graph features 504 from the graph dataset 502. For instance, the model selection system 102 utilizes a graph feature machine-learning model to generate meta-graph features 504 for each graph representation in the graph dataset 502. To illustrate, as previously described with respect to FIGS. 3-4, the model selection system 102 utilizes the graph feature machine-learning model to extract local and global structural characteristics of each graph representation. Accordingly, the model selection system 102 generates a plurality of different feature vectors representing the plurality of graph representations in the graph dataset 502, such that the meta-graph features 504 include extracted structural characteristics of a variety of different graph structures.

In additional embodiments, as illustrated in FIG. 5, the model selection system 102 also determines graph learning performance metrics 506 of the machine-learning models 500 with respect to the graph representations in the graph dataset 502. For example, the model selection system 102 determines graph learning performance metrics for each of the machine-learning models 500 in connection with each graph representation of the graph dataset 502 in one or more supervised tasks. Thus, the model selection system 102 determines a set of ground truth labels including indications of the model performances of the machine-learning models 500.

In response to determining the graph learning performance metrics 506 of the machine-learning models 500 relative to the graph dataset 502, the model selection system 102 determines mappings 508. In particular, the model selection system 102 trains the graph feature machine-learning model to learn the mappings 508 according to the meta-graph features 504 and the graph learning performance metrics 506. For example, the model selection system 102 generates a performance matrix indicating relationships or dependencies between meta-graph features of graph representations in the graph dataset 502 and model performances (e.g., accuracy and average precision). According to one or more embodiments, the model selection system 102 stores the performance matrix with the graph feature machine-learning model. In additional embodiments, the model selection system 102 trains parameters of the graph feature machine-learning model to generate predictions of model performances based on the performance matrix (e.g., using the performance matrix as ground-truth values).

In additional embodiments, the utilizes the mappings 508 to generate an additional model. Specifically, as illustrated in FIG. 5, the model selection system 102 generates a meta-graph model 510 that stores information about the machine-learning models 500 and the graph dataset 502 according to the mappings 508. More specifically, the model selection system 102 generates the meta-graph model 510 as a multi-relational graph with a plurality of nodes corresponding to the machine-learning models 500 and the graph representations of the graph dataset 502.

To illustrate, the model selection system 102 generates edges between model nodes and graph nodes to indicate the mappings 508 between the meta-graph features 504 and the graph learning performance metrics 506. Accordingly, the meta-graph model 510 includes edges indicating the strengths of the relationships between specific meta-graph features and model performances. In some embodiments, the model selection system 102 generates the meta-graph model 510 to incorporate into the graph feature machine-learning model.

In some embodiments, the model selection system 102 generates one or more different models to learn parameters of the graph feature machine-learning model based on the mappings 508. For instance, the model selection system 102 utilizes one or more graph neural networks to learn the mappings 508 indicating the relationships between the meta-graph features 504 and the graph learning performance metrics 506. In alternative embodiments, the model selection system 102 utilizes a different model, such as a multivariate regression model, a decision tree, or a multilayer perceptron, to learn parameters of the graph feature machine-learning model based on the mappings 508.

In one or more additional embodiments, the model selection system 102 updates the mappings 508 in response to utilizing the mappings 508 for a new graph representation. In particular, the model selection system 102 determines estimated graph learning performance metrics for the new graph representation according to the meta-graph features 504 and the graph learning performance metrics 506 of the mappings 508. Additionally, in some embodiments, the model selection system 102 determines ground-truth graph learning performance metrics for the new graph representation (e.g., after or otherwise in connection with generating the estimated graph learning performance metrics). The model selection system 102 determines a loss based on the difference between the ground-truth graph learning performance metrics and the estimated graph learning performance metrics and uses the loss to update the mappings 508.

According to one or more embodiments, the model selection system 102 determines a machine-learning model with a specific set of hyperparameters defined as model M={ (graph embedding method, hyperparameters), (predictor, hyperparameters)} for graph learning tasks. For example, a graph learning task involves a machine-learning model that flattens a graph representation by embedding the graph representation into a lower-dimensional space using a machine-learning model that includes a graph representation learning (embedding) model. Additionally, in a graph learning task, a system uses the embedding of the graph representation as input into a predictor model for a downstream application, such as link prediction. In each step, the machine-learning model includes specific hyperparameters to achieve an accurate embedding and to perform the downstream graph learning task. Furthermore, as previously mentioned, a plurality of different machine-learning models can include similar methods or different methods with different hyperparameters.

In one or more embodiments, given a training meta-corpus of n graph representations of datasets [symbol] ={G₁, . . . , Gₙ}, in models [symbol] ={M₁, . . . , Mₘ} for graph learning tasks, and ground truth labels Y of supervised tasks, the model selection system 102 generates a performance matrix P∈ [symbol] ^{n×m}, in which Pᵢⱼ represents the performance (e.g., accuracy, average precision, or other model graph learning performance metric) of model j on graph representation i. The model selection system 102 uses the performance matrix to select a machine-learning model for an unseen graph representation Gₜₑₛₜ∉ [symbol] by inferring the best model M*∈ [symbol] for use in a graph learning task on Gₜₑₛₜ without training or evaluating any model in [symbol] on Gₜₑₛₜ or requiring user intervention.

In one or more embodiments, given a new graph representation after generating the performance matrix, the model selection system 102 utilizes the graph feature machine-learning model to capture graph similarity of the new graph representation to training graph representations by extracting meta-graph features of the new graph representation. As mentioned, the model selection system 102 extracts the meta-graph features to be fixed-dimension for any arbitrary graph representation for easy comparison. In particular, m∈ [symbol] ^{d} represents the fixed dimension meta-graph feature vector for graph representation G.

According to one or more embodiments, to estimate how well a machine-learning model performs on a given graph representation, the model selection system 102 represents the machine-learning models and the graph representations in a latent k-dimensional space. The model selection system 102 also captures the graph-to-model affinity using a dot product similarity between two representations h_{G}_{₁} and h_{M}_{ⱼ} of the i-th graph representation Gᵢ and the j-th model Mⱼ, respectively, such that pᵢⱼ≈ [symbol] h_{G}_{₁}, h_{M}_{ⱼ} [symbol] , in which pᵢⱼ represents the performance of model Mⱼ on graph representation Gᵢ. The model selection system 102 obtains the latent representation h via a learnable function f(⋅) that uses relevant information on models and graph representations from meta-graph features m and prior knowledge of the model performances P and observed graph representations [symbol] .

In one or more embodiments, the model selection system 102 factorizes the performance matrix P into latent graph factors U∈ [symbol] ^{n×k} and model vectors V∈ [symbol] ^{m×k}. The model selection system 102 uses the model factor Vⱼ∈ [symbol] ^{k} (i.e., the j-th row of V) as the input representation of model Mⱼ. The model selection system 102 also obtains the latent embedding h_{M}_{ⱼ} of model Mⱼ by h_{M}_{ⱼ}=f(Vⱼ). In addition, for graph representations, the model selection system 102 uses the meta-graph features m and meta-training graph factors U. Although the model selection system 102 may have the same number of machine-learning models during training and inference, the model selection system 102 observes new graph representations during inference, such that the model selection system 102 cannot obtain the graph factor Uₜₑₛₜ for the test graph representation, since matrix factorization is transductive by construction (e.g., the model selection system 102 uses existing models' performance on the test graph to obtain latent factors for the test graph representation directly via matrix factorization). Accordingly, the model selection system 102 learns an estimator ϕ: [symbol] ^{d}→ [symbol] ^{k} that maps meta-graph features m into the latent factors of meta-training graph representations obtained via matrix factorization (i.e., for graph representation Gᵢ with m, ϕ(m)=Ûᵢ≈Uᵢ). The model selection system 102 combines the inputs ([m; ϕ(m)]∈ [symbol] ^{d+k} and applies a linear transformation to cause the input representation of graph representation Gᵢ to be of the same size/dimension as that of model Mⱼ, thereby obtaining the latent embedding of graph Gᵢ to be h_{G}_{ᵢ}=f (W[m; ϕ(m)]), in which W∈ [symbol] ^{k×(d+k)} is a weight matrix. Additionally, the model selection system 102 estimates the performance pᵢⱼ of model Mⱼ on graph representation Gᵢ with meta-graph features m as pᵢⱼ≈\hat{p}ᵢⱼ= [symbol] f(W[m; ϕ(m)]), f(Vⱼ) [symbol] .

In one or more embodiments, for graph learning tasks in which the goal is to estimate real values, such as accuracy, the model selection system 102 uses a loss function such as top-1 probability. For instance, for \hat{P}ᵢ∈ [symbol] ^{m} as the i-th row of \hat{P}ᵢ (e.g., the estimated performance of all m models on graph Gᵢ), the top-1 probability [symbol] (j) of the j-th model Mⱼ in the model set [symbol] represents the probability of Mⱼ to be ranked at the top of the list. More specifically, for all models in [symbol] , given the model performance \hat{P}ᵢ, the top-1 probability is:

$$\begin{matrix}{\hat{P}}_{i} \\ {p}_{top 1}\end{matrix} ( j ) = \frac{π ( {\hat{p}}_{ij} )}{{\sum }_{k = 1}^{m} π ( {\hat{p}}_{ij} )} = \frac{exp ( {\hat{p}}_{ij} )}{{\sum }_{k = 1}^{m} exp ( {\hat{p}}_{ij} )}$$

As indicated above, π(⋅) represents a strictly increasing positive function defined as an exponential function. Given that the top-1 probability [symbol] (j) for all j=1, . . . , m forms a probability distribution over all m models, the model selection system 102 obtains two probability distributions by applying top-1 probability to the true performance Pᵢ and estimated performance \hat{P}ᵢ of m models, while optimizing the graph feature machine-learning model such that the distance between two resulting distributions is decreased. Additionally, using cross-entropy as a distance metric, the model selection system 102 minimizes the following loss over all n meta-training graph representations [symbol] :

$$L ( P , \hat{P} ) = - {\sum }_{i = 1}^{m} {\sum }_{j = 1}^{m} \begin{matrix}{P}_{i} \\ {p}_{top 1}\end{matrix} ( j ) log ( \begin{matrix}{\hat{P}}_{i} \\ {p}_{top 1}\end{matrix} ( j ) )$$

In alternative embodiments, the model selection system 102 utilizes a mean squared error loss to train on the meta-training graph representations.

During a meta-training phase, the model selection system 102 learns estimators f(⋅) and ϕ(⋅), weight matrix W, and latent model factors V. Given a new test graph representation Gₜₑₛₜ, the model selection system 102 determines the meta-graph features mₜₑₛₜ∈ [symbol] ^{d}. The model selection system 102 regresses mₜₑₛₜ to obtain the approximate latent graph factors Ûₜₑₛₜ=ϕ(mₜₑₛₜ)∈ [symbol] ^{k}. Additionally, given that model factors V can be used directly for model prediction, the model selection system 102 determines the performance of model Mⱼ on test graph representation Gₜₑₛₜ as pᵢⱼ based on mₜₑₛₜ. Additionally, the model selection system 102 selects the model with the highest estimated performance as the best model M* via:

$${M}^{*} ← arg {max}_{{M}_{j} ∈ ℳ} 〈 f ( W [ {m}_{test} ; ϕ ( {m}_{test} ) ] ) , f ( {V}_{j} ) 〉$$

Given that the model selection above depends only on the meta-graph features mₜₑₛₜ of the test graph representation and other estimators and latent factors learned in the meta-training phase, the model selection system 102 does not perform training or model evaluation at inference time. Accordingly, the model selection system 102 is a fast, lightweight model during runtime relative to conventional systems that train and/or evaluate machine-learning models individually on new datasets. Furthermore, the model selection is an automated process that does not require users to choose or finetune values during inference.

As indicated above, the model selection system 102 generates meta-graph features of a graph representation for use in predicting model performance. According to one or more embodiments, the model selection system 102 captures important structural characteristics of an arbitrary graph representation to quantify and leverage the similarity between structural characteristics of different graph representations for predicting model performance. For example, the model selection system 102 captures a variety of important structural properties of graph representations corresponding to hundreds or thousands of datasets from a wide variety of different domains, including biological, technological, information, and social network domains.

In one or more embodiments, the model selection system 102 derives meta-graph features in two steps. For example, the model selection system 102 applies a set of structural feature extractors Ψ={ψ₁, . . . , ψ_{q}} to the graph representation G to obtain Ψ(G)={ψ₁(G), . . . , ψ_{q}(G)}. The model selection system 102 applies ψ∈ψ to G to yield a vector or a distribution of values for the nodes or edges in the graph representation. In particular, as previously mentioned, the model selection system 102 applies a number of different structural feature extractors to extract various structural characteristics of the nodes and edges (locally and globally). Thus, given a graph G₁=(Vᵢ, Eᵢ) and ψ, the model selection system 102 obtains a |Vᵢ|-dimensional node vector xᵢ=ψ(Gᵢ). Since any two graphs Gᵢ and Gⱼ likely have a different number of nodes and edges, the resulting structural feature matrices ψ(Gᵢ) and ψ(Gⱼ) for the graphs also likely have different sizes based on the number of rows corresponding to nodes and edges being different. Thus, generally speaking, structural feature-based representations of the graph representations are different and difficult to use in direct comparisons between graph representations.

In one or more embodiments, the model selection system 102 applies a set Σ of global statistical meta-graph extractors to each ψᵢ(G), ∀ᵢ=1, . . . , q, which summarizes each ψᵢ(G) to a vector. Specifically, the model selection system 102 applies Σ(ψᵢ(G)) including a plurality of statistical functions in Σ (e.g., mean, kurtosis) to the distribution ψᵢ(G) to determine a real number summarizing the given feature distribution ψᵢ(G) from different statistical points of view. This produces a vector Σ(ψᵢ(G))∈ [symbol] ^{|Σ|}. The model selection system 102 also obtains the meta-graph feature vector m of graph G by concatenating the resulting meta-graph feature vectors:

m=[Σ(ψ₁(G)) . . . Σ(ψᵢ(G))]∈ [symbol] ^{d}

In one or more embodiments, the global statistical functions Σ include, but are not limited to, a number of unique values, density, median of smallest/largest values, outliers, minimum/maximum values, value ranges, median, geometric mean, harmonic mean, mean, standard deviation, variance, skewness, kurtosis, efficiency ratio, signal-to-noise ratio, entropy, normalized entropy, quartile dispersion coefficients, median absolute deviation, average absolute deviation, coefficient of variation, variance-to-mean ratio, quartile max gap, centroid max gap, or histogram probability distribution. In addition to the above statistical characteristics, in one or more embodiments, the model selection system 102 also determines global graph statistics (e.g., scalars directly derived from the graph representation, such as density and degree assortativity) and appends the values to the node or edge structural features in m.

Given any arbitrary graph representation G′, the model selection system 102 determines a fixed d-dimensional meta-graph feature vector characterizing the graph representation. Accordingly, the model selection system 102 quantifies the structural similarity of any two graph representations G and G′ using a similarity function over m and m′, respectively.

Furthermore, in one or more embodiments, the model selection system 102 generates a meta-graph model as described above via the model performance matrix P and meta-graph features M. Similar models tend to have similar performance distributions over graph representations with similar features. Additionally, similar graph representations are likely to exhibit similar affinity to various models. Thus, the model selection system 102 can generate a meta-graph model that connects similar models and graph representations while learning the model and graph embeddings over the meta-graph model.

Specifically, the model selection system 102 defines a meta-graph model as a multi-relational graph with two types of nodes: model nodes and graph nodes. Additionally, edges in the meta-graph model connect similar model nodes and graph nodes. To measure the similarity among graph representations and models, the model selection system 102 utilizes the latent graph factors and model factors (U and V, respectively) obtained by factorizing the performance matrix P along with the meta-graph features M. More specifically, the model selection system 102 utilizes the estimated graph factor Û (rather than U) for leveraging the same graph construction process for new graph representations. This results in two types of features for graph nodes (Û and M), and one type of feature for model nodes (V). To allow for different features to influence the embedding step differently, as appropriate, the model selection system 102 connects graph nodes and model nodes using five types of edges: M-g2g, P-g2g, P-m2m, P-g2m, and P-m2g, where g and m denote the type of nodes that an edge connects (graph and model, respectively), and M and P indicate that the edge is based on meta-graph features and model performance, respectively. For example, M-g2g and P-g2g edges connect two graph nodes that are similar in terms of M and Û, respectively. For each edge type, the model selection system 102 constructs a k-nearest neighbor graph by connecting modes to their top-k similar nodes, in which node-to-node similarity is defined as the cosine similarity between the corresponding node features. For instance, for a P-g2m edge type, the graph nodes and model nodes are linked based on the similarity between Û and V.

Given the meta-graph model [symbol] ₜᵣₐᵢₙ that contains meta-training graph representations and models, the model selection system 102 can utilize graph neural networks (“GNNs”) to provide an effective framework to embed models and graphs via weighted neighborhood aggregation. Since the graph structure of the meta-graph model is induced by simple k-nearest neighbor search, the model selection system 102 can also use attentive neighborhood aggregation such that more informative neighbors have higher weights. Accordingly, the model selection system 102 selects attentive GNNs designed for multi-relational networks. The embedding function f(⋅) is thus defined as f(h)=GNN(h, [symbol] ₜᵣₐᵢₙ) during training to inform the input node feature h into an embedding via attentive neighborhood aggregation over [symbol] ₜᵣₐᵢₙ.

For inference, the model selection system 102 extends [symbol] ₜᵣₐᵢₙ to be a larger meta-graph model [symbol] ₜₑₛₜ that also includes test graph nodes and edges between test graph nodes along with the existing graph representations and models in [symbol] ₜᵣₐᵢₙ. The model selection system 102 performs such an extension similar to the training phase by finding top-k similar nodes. The model selection system 102 determines the embedding function for inference by f(h)=GNN(h, [symbol] ₜₑₛₜ).

In a plurality of testing scenarios involving comparisons of the model selection system 102 and existing systems, the model selection system 102 effectively achieved the highest model selection accuracy in terms of three evaluation metrics from a plurality of machine-learning models (and hyperparameters). Specifically, the model selection system 102 achieves better accuracy over conventional systems that utilize optimization-based learners that attempt to reconstruct a performance matrix via matrix factorization or regression. Furthermore, the model selection system 102 performed more efficiently (e.g., with lower runtimes) than the conventional systems that perform a search-across-all-models evaluation in the testing scenarios.

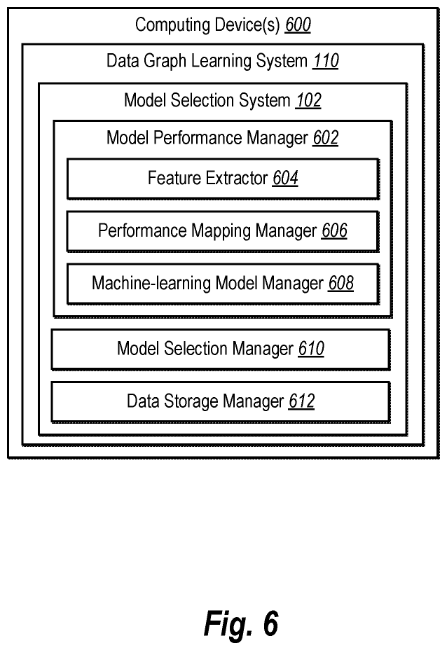

FIG. 6 illustrates a detailed schematic diagram of an embodiment of the model selection system 102 described above. As shown, the model selection system 102 is implemented in a data graph learning system 110 on computing device(s) 600 (e.g., a client device and/or server device as described in FIG. 1, and as further described below in relation to FIG. 8). Additionally, the model selection system 102 includes, but is not limited to, a model performance manager 602 (which includes a feature extractor 604, a performance mapping manager 606, and a machine-learning model manager 608), a model selection manager 610, and a data storage manager 612. The model selection system 102 can be implemented on any number of computing devices. For example, the model selection system 102 can be implemented in a distributed system of server devices for graph learning tasks. The model selection system 102 can also be implemented within one or more additional systems. Alternatively, the model selection system 102 can be implemented on a single computing device such as a single client device.

In one or more embodiments, each of the components of the model selection system 102 is in communication with other components using any suitable communication technologies. Additionally, the components of the model selection system 102 are capable of being in communication with one or more other devices including other computing devices of a user, server devices (e.g., cloud storage devices), licensing servers, or other devices/systems. It will be recognized that although the components of the model selection system 102 are shown to be separate in FIG. 6, any of the subcomponents may be combined into fewer components, such as into a single component, or divided into more components as may serve a particular implementation. Furthermore, although the components of FIG. 6 are described in connection with the model selection system 102, at least some of the components for performing operations in conjunction with the model selection system 102 described herein may be implemented on other devices within the environment.

In some embodiments, the components of the model selection system 102 include software, hardware, or both. For example, the components of the model selection system 102 include one or more instructions stored on a computer-readable storage medium and executable by processors of one or more computing devices (e.g., the computing device(s) 600). When executed by the one or more processors, the computer-executable instructions of the model selection system 102 cause the computing device(s) 600 to perform the operations described herein. Alternatively, the components of the model selection system 102 can include hardware, such as a special purpose processing device to perform a certain function or group of functions. Additionally, or alternatively, the components of the model selection system 102 can include a combination of computer-executable instructions and hardware.

Furthermore, the components of the model selection system 102 performing the functions described herein with respect to the model selection system 102 may, for example, be implemented as part of a stand-alone application, as a module of an application, as a plug-in for applications, as a library function or functions that may be called by other applications, and/or as a cloud-computing model. Thus, the components of the model selection system 102 may be implemented as part of a stand-alone application on a personal computing device or a mobile device. Alternatively, or additionally, the components of the model selection system 102 may be implemented in any application that provides digital image modification, including, but not limited to ADOBE® EXPERIENCE CLOUD®, ADOBE® CAMPAIGN, and ADOBE® AUDIENCE MANAGER.

The model selection system 102 includes a model performance manager 602 to manage the performance of a plurality of machine-learning models in connection with graph learning tasks for various datasets. As shown, the model performance manager 602 includes the feature extractor 604 to manage extraction of local and global structural and statistical features of graph representations. Specifically, the feature extractor 604 includes a graph feature machine-learning model that extracts meta-graph features from graph representations based on the nodes and edges in the graph representations. The feature extractor 604 generates a meta-graph feature vector representing the structural characteristics of each graph representation.

The model performance manager 602 also includes the performance mapping manager 606 to determine mappings of model performance of a plurality of machine-learning models to the meta-graph features of graph representations. In particular, the performance mapping manager 606 generates mappings between the meta-graph features and graph learning performance metrics of the machine-learning models. Additionally, in some embodiments, the performance mapping manager 606 communicates with the machine-learning model manager 608 to generate a meta-graph model including model nodes and graph nodes with edges linking machine-learning models and graph representations based on the mappings.

The model performance manager 602 further includes the machine-learning model manager 608 to manage a plurality of machine-learning models for graph learning tasks. For example, the machine-learning model manager 608 identifies a plurality of machine-learning models for various graph learning tasks including link prediction, node classification, graph classification, node clustering, or graph modification. In particular, the machine-learning model manager 608 manages a plurality of hyperparameters of various machine-learning models that use various methods for the different graph learning tasks. The machine-learning model manager 608 communicates with the performance mapping manager 606 to generate mappings between model performances and meta-graph features. The machine-learning model manager 608 also generates, trains, or utilizes a graph feature machine-learning model or a meta-graph model.

The model selection system 102 also includes a model selection manager 610 to select a machine-learning model for a graph learning task. In particular, the model selection manager 610 communicates with the model performance manager 602 to select a machine-learning model for a graph learning task for a graph representation of a dataset. For instance, the model selection manager 610 selects a machine-learning model corresponding to a highest estimated graph learning performance metric generated by a graph feature machine-learning model in connection with the graph representation and a plurality of machine-learning models. In some instances, the model selection manager 610 also utilizes the selected machine-learning model to perform a graph learning task.

The model selection system 102 also includes a data storage manager 612 (that comprises a non-transitory computer memory/one or more memory devices) that stores and maintains data associated with graph learning tasks. For example, the data storage manager 612 stores data associated with selecting a machine-learning model for a graph learning task, such as meta-graph features or estimated graph learning performance metrics. Additionally, the data storage manager 612 stores data (e.g., training or executing data) associated with a plurality of machine-learning models, such as a graph feature machine-learning model, a meta-graph model, or a plurality of machine-learning models for performing graph learning tasks.

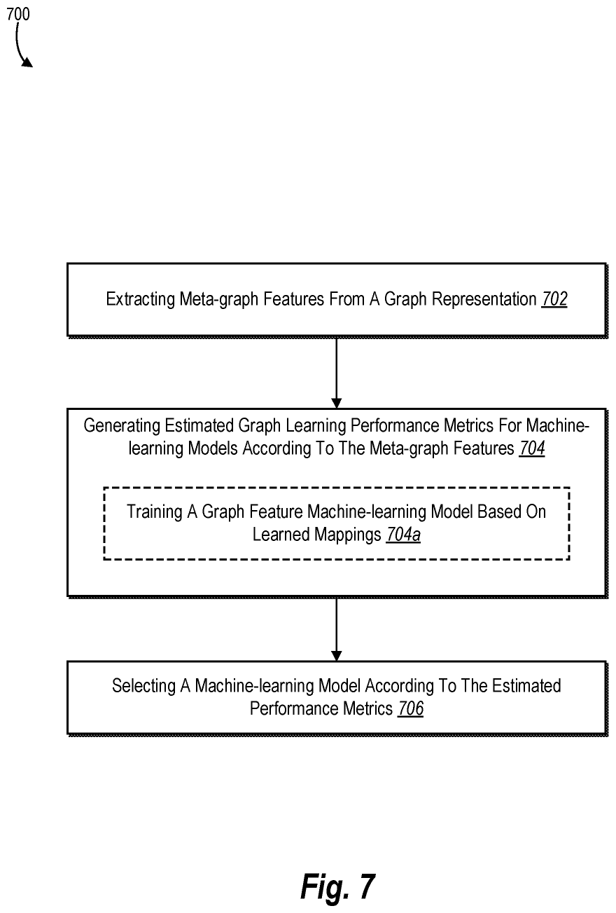

Turning now to FIG. 7, this figure shows a flowchart of a series of acts 700 of selecting a machine-learning model for a graph learning task based on meta-graph features of a graph representation. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7.

As shown, the series of acts 700 includes an act 702 of extracting meta-graph features from a graph representation. For example, act 702 involves extracting, utilizing a graph feature machine-learning model, meta-graph features representing structural characteristics of a graph representation comprising a plurality of nodes and a plurality of edges indicating relationships between the plurality of nodes. For instance, act 702 can involve extracting, utilizing a graph feature machine-learning model comprising parameters learned based on a graph dataset and corresponding model performances for a plurality of machine-learning models, meta-graph features comprising structural characteristics of a graph representation in a latent space, the graph representation comprising a plurality of nodes and a plurality of edges indicating relationships between the plurality of nodes.

Act 702 can involve generating, utilizing the graph feature machine-learning model, a plurality of structural feature matrices comprising local structural characteristics of the graph representation. Act 702 can involve extracting the meta-graph features based on the plurality of structural feature matrices.

For example, act 702 can involve extracting local structural characteristics of the plurality of nodes and the plurality of edges. For example, act 702 can involve generating one or more latent feature vectors representing a node degree, a number of wedges, a number of triangles centered at each node of the plurality of nodes, or a frequency of triangles for each edge of the plurality of edges. Act 702 can also involve extracting global structural characteristics of the plurality of nodes. Act 702 can also involve generating one or more latent feature vectors representing an importance score of each node of the plurality of nodes, an eccentricity of each node of the plurality of nodes, or a k-core number of each node of the plurality of nodes.

Act 702 can involve generating a feature matrix comprising a plurality of rows corresponding to the plurality of nodes and the plurality of edges of the graph representation according the local structural characteristics. Act 702 can also involve generating a meta-graph feature vector comprising a fixed-dimension for the graph representation based on the feature matrix utilizing the global structural characteristics. For example, act 702 can involve generating, utilizing the graph feature machine-learning model, a fixed-dimension meta-graph feature vector by modifying the plurality of structural feature matrices according to a set of global statistical characteristics associated with the graph representation.

Act 702 can involve generating a plurality of feature vectors by modifying the plurality of structural feature matrices via a plurality of statistical functions. Act 702 can also involve concatenating the plurality of feature vectors to generate the fixed-dimension meta-graph feature vector. Act 702 can also involve appending one or more scalar statistical metrics determined from the graph representation to the concatenated plurality of feature vectors in the fixed-dimension meta-graph feature vector.

The series of acts 700 also includes an act 704 of generating estimated graph learning performance metrics for machine-learning models according to the meta-graph features. For example, act 704 involves generating, utilizing the graph feature machine -learning model, a plurality of estimated graph learning performance metrics for a plurality of machine-learning models according to the meta-graph features, wherein the plurality of estimated graph learning performance metrics indicate predicted performances of the plurality of machine-learning models in a graph learning task for the graph representation. Act 704 can involve generating, utilizing the graph feature machine-learning model, a plurality of estimated graph learning performance metrics for a plurality of machine-learning models according to the meta-graph features and learned mappings between the meta-graph features and graph learning performance metrics of the plurality of machine-learning models. Act 704 can involve determining, utilizing the graph feature machine-learning model, based on learned mappings between meta-graph features and model graph learning performance metrics of the plurality of machine-learning models.

Act 704 can involve generating, for a first machine-learning model of the plurality of machine-learning models, a first estimated graph learning performance metric according to the meta-graph features. Act 704 can also involve generating, for a second machine-learning model of the plurality of machine-learning models, a second estimated graph learning performance metric according to the meta-graph features.

Act 704 can involve generating a meta-graph comprising a plurality of graph nodes corresponding to graph features for a graph dataset and a plurality of model nodes corresponding to model factors for the plurality of machine-learning models. For example, act 704 can involve determining the graph features for the graph dataset and the model factors for the plurality of machine-learning models by factorizing a performance matrix comprising model graph learning performance metrics of the plurality of machine-learning models according to the graph dataset. Act 704 can involve generating the plurality of estimated graph learning performance metrics based on the meta-graph features and relationships between the plurality of graph nodes and the plurality of model nodes in the meta-graph.

Additionally, the series of acts 700 also optionally includes an act 704a of training a graph feature machine-learning model based on learned mappings. For example, act 704a can involve extracting, utilizing the graph feature machine-learning model, a plurality of sets of meta-graph features for training graph representations in the graph dataset. Act 704a can also involve generating, for the plurality of machine-learning models, a plurality of sets of ground-truth graph learning performance metrics according to the plurality of sets of meta-graph features. Act 704a can further involve learning the parameters of the graph feature machine-learning model by determining mappings between the plurality of sets of meta-graph features and the plurality of sets of ground-truth graph learning performance metrics. Additionally, act 704 can involve generating the plurality of estimated graph learning performance metrics based on learned mappings between meta-graph features of training graph representations of a graph dataset and graph learning performance metrics of the plurality of machine-learning models corresponding to the training graph representations.

The series of acts 700 further includes an act 706 of selecting a machine-learning model according to the estimated graph learning performance metrics. For example, act 706 involves selecting a machine-learning model to process data associated with the graph representation according to the plurality of estimated graph learning performance metrics.

Act 706 can involve selecting a machine-learning model of the plurality of machine-learning models corresponding to a highest estimated graph learning performance metric of the plurality of estimated graph learning performance metrics. For example, act 706 can involve selecting the first machine-learning model in response to determining that the first estimated graph learning performance metric is higher than the second estimated graph learning performance metric.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that may be configured to perform one or more of the processes described above. One will appreciate that one or more computing devices such as the computing device 800 may implement the system(s) of FIG. 1. As shown by FIG. 8, the computing device 800 can comprise a processor 802, a memory 804, a storage device 806, an I/O interface 808, and a communication interface 810, which may be communicatively coupled by way of a communication infrastructure 812. In certain embodiments, the computing device 800 can include fewer or more components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions for dynamically modifying workflows, the processor 802 may retrieve (or fetch) the instructions from an internal register, an internal cache, the memory 804, or the storage device 806 and decode and execute them. The memory 804 may be a volatile or non-volatile memory used for storing data, metadata, and programs for execution by the processor(s). The storage device 806 includes storage, such as a hard disk, flash disk drive, or other digital storage device, for storing data or instructions for performing the methods described herein.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example, and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 810 may facilitate communications with various types of wired or wireless networks. The communication interface 810 may also facilitate communications using various communication protocols. The communication infrastructure 812 may also include hardware, software, or both that couples components of the computing device 800 to each other. For example, the communication interface 810 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
extracting, utilizing a graph feature machine-learning model, meta-graph features representing structural characteristics of a graph representation comprising a plurality of nodes and a plurality of edges indicating relationships between the plurality of nodes;
generating, utilizing the graph feature machine-learning model, a plurality of estimated graph learning performance metrics for a plurality of machine-learning models according to the meta-graph features, wherein the plurality of estimated graph learning performance metrics indicate predicted performances of the plurality of machine-learning models in a graph learning task for the graph representation; and
selecting a machine-learning model to process data associated with the graph representation according to the plurality of estimated graph learning performance metrics. and

2. The method of claim 1, wherein extracting the meta-graph features comprises:
extracting local structural characteristics of the plurality of nodes and the plurality of edges; and
extracting global structural characteristics of the plurality of nodes.

3. The method of claim 2, wherein extracting the meta-graph features comprises:
generating a feature matrix comprising a plurality of rows corresponding to the plurality of nodes and the plurality of edges of the graph representation according the local structural characteristics; and
generating a meta-graph feature vector comprising a fixed-dimension for the graph representation based on the feature matrix utilizing the global structural characteristics.

4. The method of claim 2, wherein extracting the local structural characteristics comprises generating one or more latent feature vectors representing a node degree, a number of wedges, a number of triangles centered at each node of the plurality of nodes, or a frequency of triangles for each edge of the plurality of edges.

5. The method of claim 2, wherein extracting the global structural characteristics comprises generating one or more latent feature vectors representing an importance score of each node of the plurality of nodes, an eccentricity of each node of the plurality of nodes, or a k-core number of each node of the plurality of nodes.

6. The method of claim 1, wherein generating the plurality of estimated graph learning performance metrics comprises determining, utilizing the graph feature machine-learning model, based on learned mappings between meta-graph features and model graph learning performance metrics of the plurality of machine-learning models.

7. The method of claim 1, wherein generating the plurality of estimated graph learning performance metrics comprises:
generating a meta-graph comprising a plurality of graph nodes corresponding to graph features for a graph dataset and a plurality of model nodes corresponding to model factors for the plurality of machine-learning models; and
generating the plurality of estimated graph learning performance metrics based on the meta-graph features and relationships between the plurality of graph nodes and the plurality of model nodes in the meta-graph.

8. The method of claim 7, wherein generating the meta-graph comprises determining the graph features for the graph dataset and the model factors for the plurality of machine-learning models by factorizing a performance matrix comprising model graph learning performance metrics of the plurality of machine-learning models according to the graph dataset.

9. A system comprising:
a memory component; and
a processing device coupled to the memory component, the processing device to perform operations comprising:
extracting, utilizing a graph feature machine-learning model comprising parameters learned based on a graph dataset and corresponding model graph learning performances for a plurality of machine-learning models, meta-graph features comprising structural characteristics of a graph representation in a latent space, the graph representation comprising a plurality of nodes and a plurality of edges indicating relationships between the plurality of nodes;
generating, utilizing the graph feature machine-learning model, a plurality of estimated graph learning performance metrics for the plurality of machine-learning models according to the meta-graph features, wherein the plurality of estimated graph learning performance metrics indicate predicted performances of the plurality of machine-learning models in a graph learning task for the graph representation; and
selecting a machine-learning model to process data associated with the graph representation according to the plurality of estimated graph learning performance metrics.

10. The system of claim 9, wherein extracting the meta-graph features comprises:
generating, utilizing the graph feature machine-learning model, a plurality of structural feature matrices comprising local structural characteristics of the graph representation; and
extracting the meta-graph features based on the plurality of structural feature matrices.

11. The system of claim 10, wherein extracting the meta-graph features comprises generating, utilizing the graph feature machine-learning model, a fixed-dimension meta-graph feature vector by modifying the plurality of structural feature matrices according to a set of global statistical characteristics associated with the graph representation.

12. The system of claim 11, wherein generating the fixed-dimension meta-graph feature vector comprises:
generating a plurality of feature vectors by modifying the plurality of structural feature matrices via a plurality of statistical functions; and
concatenating the plurality of feature vectors to generate the fixed-dimension meta-graph feature vector.

13. The system of claim 12, wherein extracting the meta-graph features further comprises appending one or more scalar statistical metrics determined from the graph representation to the concatenated plurality of feature vectors in the fixed-dimension meta-graph feature vector.

14. The system of claim 9, wherein generating the plurality of estimated graph learning performance metrics comprises:
generating, for a first machine-learning model of the plurality of machine-learning models, a first estimated performance metric according to the meta-graph features; and
generating, for a second machine-learning model of the plurality of machine-learning models, a second estimated performance metric according to the meta-graph features.

15. The system of claim 14, wherein selecting the machine-learning model to process the data associated with the graph representation comprises selecting the first machine-learning model in response to determining that the first estimated performance metric is higher than the second estimated performance metric.

16. The system of claim 9, wherein the processing device further performs operations comprising:
extracting, utilizing the graph feature machine-learning model, a plurality of sets of meta-graph features for training graph representations in the graph dataset;
generating, for the plurality of machine-learning models, a plurality of sets of ground-truth graph learning performance metrics according to the plurality of sets of meta-graph features; and
learning the parameters of the graph feature machine-learning model by determining mappings between the plurality of sets of meta-graph features and the plurality of sets of ground-truth graph learning performance metrics.

17. A non-transitory computer-readable medium storing executable instructions, which when executed by a processing device, cause the processing device to perform operations comprising:
extracting, utilizing a graph feature machine-learning model, meta-graph features comprising local structural characteristics and global structural characteristics of a graph representation in a latent space, the graph representation comprising a plurality of nodes and a plurality of edges indicating relationships between the plurality of nodes;
generating, utilizing the graph feature machine-learning model, a plurality of estimated graph learning performance metrics for a plurality of machine-learning models according to the meta-graph features and learned mappings between the meta-graph features and graph learning performance metrics of the plurality of machine-learning models, wherein the plurality of estimated graph learning performance metrics indicate predicted performances of the plurality of machine-learning models in a graph learning task for the graph representation; and
selecting a machine-learning model to process data associated with the graph representation according to the plurality of estimated graph learning performance metrics.

18. The non-transitory computer-readable medium of claim 17, wherein extracting the meta-graph features comprises:
generating, utilizing the graph feature machine-learning model, a plurality of structural feature matrices comprising local structural characteristics of the graph representation; and
generating, utilizing the graph feature machine-learning model, a fixed-dimension meta-graph feature vector by modifying the plurality of structural feature matrices according to a set of global statistical characteristics associated with the graph representation.

19. The non-transitory computer-readable medium of claim 17, wherein generating the plurality of estimated graph learning performance metrics comprises generating the plurality of estimated graph learning performance metrics based on learned mappings between meta-graph features of training graph representations of a graph dataset and graph learning performance metrics of the plurality of machine-learning models corresponding to the training graph representations.

20. The non-transitory computer-readable medium of claim 17, wherein selecting the machine-learning model to process the data associated with the graph representation comprises selecting a machine-learning model of the plurality of machine-learning models corresponding to a highest estimated performance metric of the plurality of estimated graph learning performance metrics.
